(19) United States
(12) Patent Application Publication
(10) Pub. No.: US 2022/0244084 A1
(43) Pub. Date: Aug. 4, 2022

(54) METHOD AND DEVICE FOR ASCERTAINING A FLOW PARAMETER USING A CORIOLIS FLOW METER

(71) Applicant: HEINRICHS MESSTECHNIK GMBH, Köln (DE)

(72) Inventor: Thomas Chatzikonstantinou, Aachen (DE)

(21) Appl. No.: 17/621,808

(22) PCT Filed: Jun. 24, 2020
(86) PCT No.: PCT/DE2020/100543

§ 371 Date: Dec. 22, 2021

(30) Foreign Application Priority Data
Jun. 24, 2019 (DE) 10 2019 116 872.4

(51) Int. Cl. G01F 1/84; G01F 25/10; G01N 11/16; G01N 11/02; G01N 9/00

(52) U.S. Cl. CPC G01F 1/8468; G01F 1/8422; G01F 1/8413; G01F 25/10; G01N 2011/0073; G01N 11/02; G01N 9/002; G01N 2009/006; G01N 11/16

(57) ABSTRACT

The invention relates to a method for ascertaining a flow parameter of a medium, in particular the mass flow rate, using a Coriolis flow meter of a specified measurement device type and to a device which is suitable for said method. According to the method, the medium, which has a medium viscosity, flows through at least one measurement tube piece that is mechanically vibrated by a respective excitation signal, at least one measurement signal dependent on the flow parameter, in particular a phase shift, is ascertained in the vibration behavior of the respective measurement tube piece, and the flow parameter is determined from the at least one measurement signal while taking into consideration the dependency of the flow parameter on the medium viscosity, wherein a data field which is ascertained using an interpolation method, in particular a kriging method, and which indicates the dependency of the flow parameter on the medium viscosity is used in order to determine the flow parameter.

The invention relates to a method and a device for determining a flow parameter by means of a Coriolis flowmeter.

Devices for Coriolis flow measurement are known from the prior art (see, for example, DE 20 2017 006 709 U1) and are used in particular to determine the mass flow rate and/or the density of a fluid flowing through. Coriolis flowmeters have at least one measuring tube in a transducer through which the fluid, the mass flow rate and/or density of which is to be determined, flows. The at least one measuring tube is made to vibrate by means of a vibration exciter, while the vibrations of the measuring tube are simultaneously measured by means of vibration sensors at separate measuring points. If no fluid flows through the measuring tube during the measurement, the measuring tube vibrates with the same phase at both measuring points. When fluid flows, on the other hand, phase shifts occur at the two measuring points due to occurring Coriolis forces, said phase shifts being a direct measure of the mass flow rate, that is, the mass of the fluid flowing through the measuring tube in question per unit of time. In addition, the natural frequency of the measuring tube at the measuring points is directly dependent on the density of the fluid flowing through, so that the fluid's density can also be determined.

Coriolis flowmeters are used in many areas of technology, for example, in pipeline billing measurements, in loading processes, for example, when loading tankers with crude oil or gas, or in dosing processes.

The influence of the determinants mass flow and/or density on the measured variables phase shift or frequency depends not only on the type of Coriolis flowmeter, but also on the temperature, pressure and viscosity of the medium to be measured. The use of temperature compensation is known to correct temperature-related measurement errors in Coriolis flowmeters. For this purpose, the temperature of the fluid is continuously measured by means of a temperature sensor attached to the Coriolis mass flowmeter at a suitable point and the density and/or mass flow is set in relation to a reference state, here a reference temperature, by means of mostly linear approximation formulas. A similar procedure, that is, by means of mostly linear approximation formulas in relation to a reference state, here a reference pressure, is used to correct pressure-related measurement errors in Coriolis flowmeters. Coriolis mass flowmeters usually do not have a pressure sensor, which is why, in contrast to the temperature, the pressure is not measured continuously but entered by the user, usually manually, on the electronic evaluation unit. Formulas for density and flow rate correction, for example, by means of linear temperature and pressure compensation, are known in the prior art.

In contrast to the case of temperature and pressure, the influence of viscosity on the measurement results of Coriolis mass flowmeters is largely neglected in the prior art. Thus, in standard works of flow measurement technology such as in the book “Flow Measurement”, Bela G. Liptak, CRC Press, ISBN 9780801983863, page 60, it can be read that there is little documented information about the influence of viscosity on the accuracy of Coriolis flowmeters, but also that such inaccuracies have been reported without, however, being confirmed by documented test data.

Because of the ever-increasing demands on the accuracy of Coriolis flowmeters, on the one hand, the viscosity of the fluid to be measured is increasingly cited as a possible source of error (see, for example, “Factors Affecting Coriolis Flowmeters”, Chris Mills, NEL, Mar. 25, 2014). On the other hand, however, the influence of viscosity on the measurement results of Coriolis mass flowmeters is hardly given any importance in practice. For example, the review of the operating instructions of leading manufacturers of Coriolis mass flowmeters has shown that up to now, they have neither read nor processed the viscosity values of the fluid to be measured in the electronic evaluation unit of the Coriolis mass flowmeter. Note well that, even though considerable measurement errors occur, in particular with low Reynolds numbers, said errors can amount to several percentage points, especially if, as regularly, water is used as the calibration medium. This effect is particularly pronounced when using a device calibrated with water when using a fluid having a high to very high viscosity. The same applies to very large Coriolis flowmeters, such as those used at large loading terminals for hydrocarbons or bitumen. But even with low viscosities and simultaneously very low mass flows of the fluid, such as small Coriolis flowmeters that are used in the kilogram per hour range, measurement errors based on the influence of viscosity should not be neglected.

WO 2015/086224 A1 discloses a density measuring device, in particular a Coriolis mass flowmeter/density measuring device, in which it is proposed not to use the resonance frequency of the transducer measuring tube for measuring the density or the mass flow of the fluid flowing through a transducer, but rather a frequency deviating therefrom, which should result in a preferred phase shift. The optimal measurement frequency leads to independence from the influence of viscosity on the measurement result. The optimal phase shift angle can be determined experimentally and/or with simulation calculations.

When assessing the previous state of the art, WO 2015/086224 A1 states that the damping of the useful vibrations caused by dissipation of vibration energy in heat is a further influencing variable that influences the resonance frequency serving as the useful frequency to a not easily negligible extent or to which the density measuring device can have a certain cross-sensitivity. With an intact transducer, changes in damping and the associated changes in the corresponding resonance frequency would also be determined to a considerable extent by changes in the viscosity of the medium to be measured, and this such that the respective resonance frequency decreases with increasing viscosity despite the constant density. It was proposed to correct the change in the resonance frequency by first determining the viscosity of the fluid flowing through the transducer by means of the measuring device electronics from the measurement signals of the transducer. The measured variable to be determined, here the density value of the fluid, can be determined using the viscosity measured value and a correspondingly extended characteristic curve function that also takes into account the change in the resonance frequency caused by changes in viscosity.

DE 100 20 606 A1 discloses devices and methods for Coriolis flow measurement which allow the viscosity to be determined and, at the same time, the density and mass flow of the fluid flowing through to be measured,

U.S. Pat. No. 5,027,662 A discloses a Coriolis flowmeter in which, in certain embodiments, a damping dependent on the viscosity is taken into account to determine the mass flow. For this purpose, the damping is determined from the measured values without the viscosity values themselves being determined.

It is stated as known from “Numerical Simulations of Coriolis Row Meters for Low Reynolds Number Flows” (Vivek Kumar and Martin Anklin, Endress+Hauser FLOWTEC Journal of Metrology Society India, Vol 26, No 3, 2011, pp. 225-235) that there is a need to correct the measured values of Coriolis flowmeters at low Reynolds numbers and that this is done according to the manufacturer's own information based on the Reynolds number. The Reynolds number is indirectly proportional to the dynamic viscosity and proportionally to the flow velocity of the fluid and the nominal diameter of the measuring tube. The Reynolds number is thus only a similarity parameter and, as such, is very useful in many applications in flow technology, but due to the further dependencies, it is not sufficient to take into account the special influence of viscosity in Coriolis flowmeters. This viscosity compensation based on the Reynolds number is independent of the structure of the Coriolis flowmeter, that is, for example, the shape of the measuring tubes, the housing, and the material, since a correction function according to the Reynolds number treats Coriolis flowmeters of different sizes and with different loop shapes in the same way, if they move into correction-relevant Reynolds ranges during operation, although the flow conditions in the measuring tubes change significantly depending in particular on their shape or size. Depending on the speed and viscosity, these can be relatively large or very small Coriolis flowmeters.

The compensation based on the Reynolds number gives the impression of validity for all devices, regardless of the manufacturer. However, this is not applicable, because with the compensation based on the Reynolds number, important local effects that are related to the special features of the device type and influence measurement accuracy are not taken into account, for example, locally different diameters of the measuring tubes over the course of the measuring tube, local wrinkles in the wall of the measuring tubes arising from measuring tube bending processes, locally different surface quality of the inside of the measuring tubes, but also other effects, all of which, together with the shape of the measuring tubes, change the velocity profile of the flow along the measuring tubes. A constant, undisturbed velocity profile of the flow along the measuring tubes cannot therefore be assumed. In addition, the measuring principle of Coriolis flowmeters results in interactions between the fluid to be measured, the structure of the Coriolis flowmeter and its surroundings due to the unsteady, that is, dynamic fluid structure. For such unsteady physical phenomena, compensation by means of the Reynolds number, which by definition is only a static similarity parameter, is fundamentally ineffective.

EP 1 281 938 B1 discloses taking into account the viscosity of the fluid for correcting an intermediate value determined for the mass flow of a fluid. For this purpose, the viscosity is measured and, from the measurement signal representative of the viscosity and the intermediate value, a further measurement signal representative of the Reynolds number is generated, on the basis of which the intermediate value is then corrected. Ultimately, therefore, the Reynolds number is decisive, which brings with it the problems presented above with regard to the accuracy of the measured value.

A Coriolis flowmeter is known from EP 1725839 B1, the viscosity of the fluid flowing through the measuring device being taken into account when it is operated to compensate for measurement errors in the mass flow measurement. The viscosity value is determined during operation or is determined in advance as a specified reference viscosity and entered manually from a remote control room or on site, knowing the medium to be measured. To determine the actual mass flow, a first intermediate value for the mass flow is offset against a correction value. The correction value in turn is calculated from the specified or measured viscosity value and a second intermediate value, the second intermediate value corresponding to a damping of the vibrations of the measuring tube that is dependent on an apparent viscosity of the medium carried in the measuring tube. To determine the correction value, the deviation of the apparent viscosity determined via the second intermediate value from the specified or measured viscosity is taken into account. The relationship between the correction value and the second intermediate value can be mapped with a clear relationship in a table memory of a measuring device electronics. The table memory has a set of digital correction values that were determined, for example, during the calibration of the Coriolis flowmeter. A measured second intermediate value is compared with the default values stored in the table memory for the second intermediate value and the closest of these is used to determine the correction value.

It is generally known from the prior art to determine the relationship between phase shift and mass flow, which is decisive for the measurement, by means of calibration of the Coriolis flowmeter. Water is used almost exclusively as the calibration medium in the prior art. If one disregards general flow-induced non-linearities, this relationship is almost linear for water in most cases, which is why, according to the prior art, the linear relationship between phase angle and mass flow is adopted and represented by means of a proportionality constant, the so-called device parameter. This device parameter, sometimes also called device constant, is usually printed on the nameplate of every Coriolis flowmeter produced. Device constants of devices of the same size and type do not differ significantly from one another.

If, as is the rule in the prior art, measurements are carried out with fluids of other viscosities using a device calibrated with water, measurement errors that easily exceed the accuracy of the device based on the calibration medium water by a factor of ten or more can result. The following sets out an exemplary table which, depending on the viscosity of the medium and the uncorrected mass flow, shows the measurement errors in percent that would result if the viscosity of the measurement medium, which deviates from the calibration medium water, is neglected for the measurement result.

| | 1 | 30 | 290 | 410 | 590 |
|---|---|---|---|---|---|
| MD\n | mPas | mPas | mPas | mPas | mPas |
| 20,000 kg/h | 0.0% | −0.49% | −0.85% | −0.92% | −1.03% |
| 40,000 kg/h | 0.0% | −0.38% | −0.73% | −0.74% | −0.78% |
| 60,000 kg/h | 0.0% | −0.34% | −0.67% | −0.64% | −0.68% |
| 100,000 kg/h | 0.0% | −0.32% | −0.57% | −0.53% | −0.60% |
| 160,000 kg/h | 0.0% | −0.28% | −0.29% | −0.42% | −0.57% |
| 200,000 kg/h | 0.0% | −0.28% | −0.29% | −0.42% | −0.57% |

The first column presents the uncorrected mass flow values and the first line presents the viscosity values of the measuring medium.

For example, in a Coriolis flowmeter type available on the market, the error is thus −1.03% compared to calibration with water (viscosity 1 mPas) when measuring 20,000 kg/h of a liquid having a viscosity of 590 mPas. 1.03% must be added to the measured flow value to obtain the correct mass flow value.

Taking into account the fact that Coriolis flowmeters available on the market are specified with accuracies of 0.1% or even 0.05%, it is immediately apparent that the viscosity of the measuring medium influences the accuracy of the devices by a factor of 5, 10 or even more. As mentioned above, this phenomenon does not depend on the Reynolds number, but differs depending on the type of measuring device, so that with other types of measuring devices (for example, with other measuring tube shapes), completely different errors mill occur in terms of numbers.

The creation of tables of the type shown above having a resolution sufficient for viscosity compensation is problematic in practice, since this would involve a correspondingly high number of measurements and/or simulations. Thirty-six measurements and/or simulations are required for the very rough error table shown above, which is also only valid for a specific Coriolis flowmeter type, which entails a high expenditure of time and money.

The problem presented also arises if, in contrast to the usual procedure, a calibration medium other than water is used.

The invention is based on the technical problem of providing a method and a device of the type mentioned above, which allow an improved consideration of the influence of the viscosity on the measurement result. In particular, the novel method and the novel device should be practical, economical and as precise as possible.

This problem is solved with regard to the method having the features of claim 1, with regard to the device of the type mentioned above having the characterizing features of claim 6. Advantageous embodiments emerge from the dependent claims.

In a method for determining a flow parameter of a medium, in particular a mass flow, by means of a Coriolis flowmeter, the medium having a medium viscosity accordingly flows through at least one measuring tube piece, which is excited to mechanical vibrations by means of an excitation signal. At least one measurement signal dependent on the flow parameter, in particular a phase shift, is determined in the vibration behavior of the respective measuring tube piece, the flow parameter being determined from the at least one measurement signal taking into account the dependence of the flow parameter on the medium viscosity, a data field determined by means of an interpolation method and showing the dependence of the flow parameter on the medium viscosity being used to determine the flow parameter.

In particular, the method according to the invention can be implemented such that the interpolation method for determining a data field is applied to a basic data set determined experimentally and/or by simulation. The basic data set can be stored, for example, in the form of a table, in the Coriolis flowmeter itself or in an external memory. The basic data set can be generated experimentally, for example, through tests of media having different viscosities, or through simulation calculations, or through a combination of both methods. The basic data set can consist of a small number of data items, since a large number of measurements, but also of simulations, is generally not sensible for economic or practical reasons. A basic data set that is as small as possible is desirable, since a separate data field or characteristic diagram should be determined for each type of measuring device.

The basic data set can, for example, be a table that specifies for certain viscosity values the respective error that arises, compared to a device type calibrated with water or another calibration medium, for flow parameter values, for example, mass flow values, that have not yet been measured taking into account the influence of viscosity. Such an exemplary basic data set is depicted in the introduction to the description. Of course, the basic data set can also have a different structure with different data, as long as this results in the dependence of the mass flow or the other flow parameter to be determined on the medium viscosity. In particular, the basic data set can also specify the errors in absolute values instead of percentages. As a further alternative, instead of values representing errors, it is also possible to specify already corrected mass flow values. The same naturally also applies to the data fields or characteristic diagrams that are generated with the aid of the interpolation method. Insofar as the specification of percent is assumed in the following description in connection with basic data sets, data fields or characteristic diagrams, the same also applies to alternative structures which specify the error in a different way or which specify mass flow values that have already been corrected.

Instead of the mass flow of the medium, the density of the medium flowing through the Coriolis flowmeter can also be measured as a flow parameter, for example. Insofar as the following statements relate to the mass flow, this can also apply in an analogous manner to other flow parameters, such as the density, for example. For density measurements, for example, a suitable data field can also be generated and used by means of interpolation, with which data field viscosity-related errors in the density measurement relative to a reference density measurement can be determined and the measured values can be corrected.

Using the interpolation method, a data field of higher data density that is sufficiently fine for the required accuracy is generated from the basic data set having a relatively low data density or number of data items. The data field can be in the form of a table or a characteristic diagram. Insofar as a characteristic diagram is assumed for the sake of easier readability for the following presentation of the method according to the invention and the device according to the invention, this also applies correspondingly to tables or other forms of data fields.

The interpolation method does not have to be part of the measuring method according to the invention itself, but can be used in advance, for example, during calibration or after calibration of the type of measuring device. The resulting data field can be stored as a table or as a characteristic diagram for all Coriolis flowmeters of the calibrated measuring device type, for example, in the measuring device electronics unit of each Coriolis flowmeter or in an external unit, and used for the actual measurement. The measuring method is characterized by the fact that it uses the data field used with interpolation for the actual measurement. However, it is also possible for the interpolation method to be used during the measurement for an evaluation during or after the determination of the at least one measurement signal. In this case, the basic data set is stored externally or in the Coriolis flowmeter itself.

The medium viscosity can, for example, be entered manually on the Coriolis flowmeter or made available for measurement in some other way, for example, by means of a measurement on the medium. The medium viscosity can also depend on pressure or temperature, which can also be taken into account for the method according to the invention.

The method according to the invention can also be carried out such that the interpolation method is used when calibrating the device type. In this case, the finished characteristic diagram can already be stored in the specific Coriolis flowmeter, for example, in a measuring device electronics unit or in an external unit.

The interpolation method used can also be a combination of individual interpolation methods, for example, linear interpolation or interpolation using higher-grade polynomials. Any suitable interpolation method can be used. An interpolation method in the sense of the method according to the invention is to be understood as any method that is able to generate a data field that is as fine as possible, ideally without gaps, starting from a basic data set, with the aid of which the influence of the medium viscosity can be taken into account when measuring the flow parameters, in particular the mass flow. In particular, when using a Coriolis flowmeter, the device type of which has been calibrated with a calibration medium that differs from the measuring medium, in particular with water, a viscosity-related measurement deviation compared to the calibration medium can be determined and the correct flow parameter, in particular the mass flow, can be determined for each medium.

The method according to the invention can be carried out in a particularly advantageous manner in that at least kriging is also used as the interpolation method.

Kriging is an interpolation method that goes back to Danie Krige and is known in the prior art in connection with geostatistical methods and outside of geostatistics as Gaussian process regression. In geostatistics, stochastic methods are used to characterize and estimate data, for example, to determine the distribution of surface temperatures in land areas or bodies of water. For this purpose, measured values are recorded at individual points in the area to be examined, which measured values are then used as starting points for a spatial interpolation. Any number of estimated values can be determined from a finite number of measured values, which estimated values should represent reality as precisely as possible.

In the kriging method, spatial variance is taken into account in geostatistics, and semivariograms are used to determine this. The measured values used for the calculation are weighted such that the estimation error variance is as low as possible, which is a particular advantage in comparison to other interpolation methods with regard to the accuracy of the estimation of the intermediate values. With kriging, in comparison to other interpolation methods, in particular also to higher-grade polynomials, a higher degree of accuracy can generally be achieved in particular with a small number of data points, that is, with a small basic data set. In contrast to alternative interpolation methods, the kriging result cannot be specified in a closed form, for example, as a polynomial. Kriging is complex and usually uses inversion and multiplication of several matrices. Since kriging is therefore very computationally and memory-intensive, the use of kriging to resolve a rough basic data set as finely as desired should be avoided. Rather, for a procedure that is optimized in terms of time and memory requirements, it can be advantageous to get a refined matrix from the basic data set by means of kriging in a first stage, for example, refined by a factor of 5, 10 or 100, and to use other, less complex interpolation methods for a further refinement between the values obtained by means of kriging. The result of the less complex interpolation method can then in turn be specified in a closed form, for example, linear.

An embodiment of the method according to the invention is presented below with the aid of figures.

FIG. 1 shows again the table already set out in the introduction to the description having percentage deviations of the measured uncorrected mass flow values, that is, those based on a calibration of the measuring device with water, in kg/h from actual mass flow values, determined experimentally by measurements and/or simulation methods, which mass flow values result when taking into account the medium viscosity (here in mPas) of the medium flowing through a Coriolis flowmeter of the calibrated measuring device type. The table thus shows a basic data set having a data volume for which measurements or simulation calculations still represent an acceptable expense.

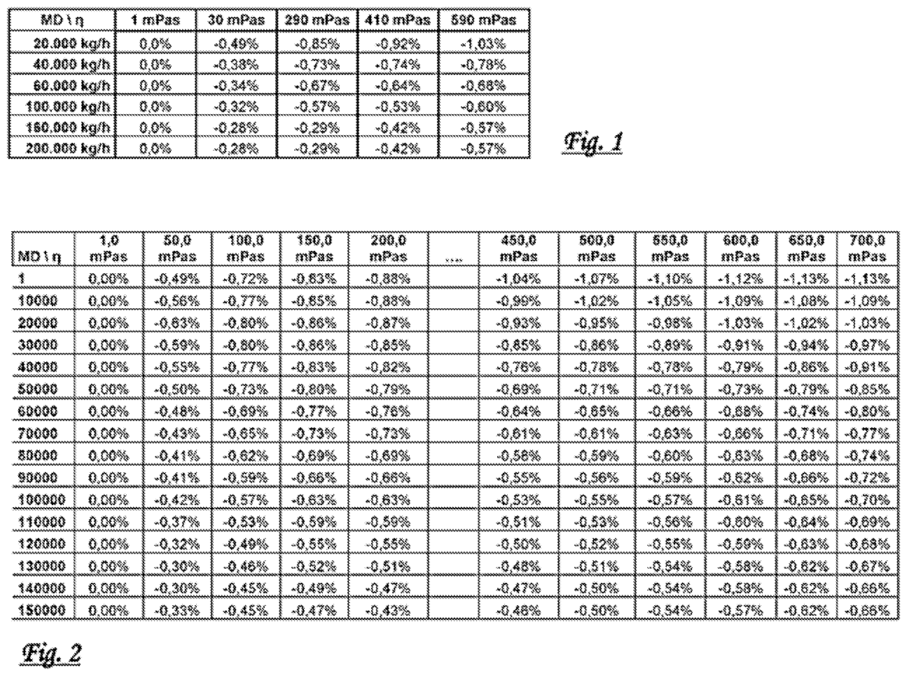

A kriging method is now used as the interpolation method on the basic data set of the table according to FIG. 1. The data field is thus completed starting from the relatively small number of output values, so that a data field having a significantly increased resolution is achieved, as is exemplified, for example, from excerpts from the table in FIG. 2. There are several possibilities for the concrete application of kriging to a basic data set, as is depicted in the table according to FIG. 1. In principle, the kriging method can be programmed by the user himself. However, suitable kriging software can be purchased or is even available free of charge, including the source code. In particular, there is the option of integrating suitable additional functions in spreadsheet programs such as Microsoft Excel®, such as the XonGrid add-in, which was available at http://xongrid.sourceforge.net/ at the time this application was submitted and offers kriging in addition to other interpolation methods.

Finally, reference is also made to the comments on kriging in the publication “Optimale Methoden zur Interpolation von Umweltvariablen in Geographischen Informationssystemen” (Optimal methods for the interpolation of environmental variables in geographic information systems) by P.A. Burrough in Geographica Helvetica 1990 no. 4, p. 159-160.

The refined table according to FIG. 2 obtained by means of kriging also shows, in the first column, the mass flow in kWh that would be measured using a Coriolis flowmeter calibrated with water without taking into account the medium viscosity. This mass flow is referred to below as the calibration medium mass flow. The media viscosity is set out in the first line in mPas.

The following can be read from the data field as an example: If a calibration medium mass flow of 110,000 kg/h, that is, 110 tons per hour, were measured without taking the medium viscosity into account, this would mean an error of −0.6% with an actual medium viscosity of 600 mPas. This means that the actual measuring medium mass flow is 0.6% higher than the calibration medium mass flow, namely 110,000 kg/h*1.006=110,660 kg/h.

If necessary, the data field can be further refined as required, for example, by further application of the kriging method or preferably by less complex interpolation methods, such as linear interpolation or higher-grade polynomials.

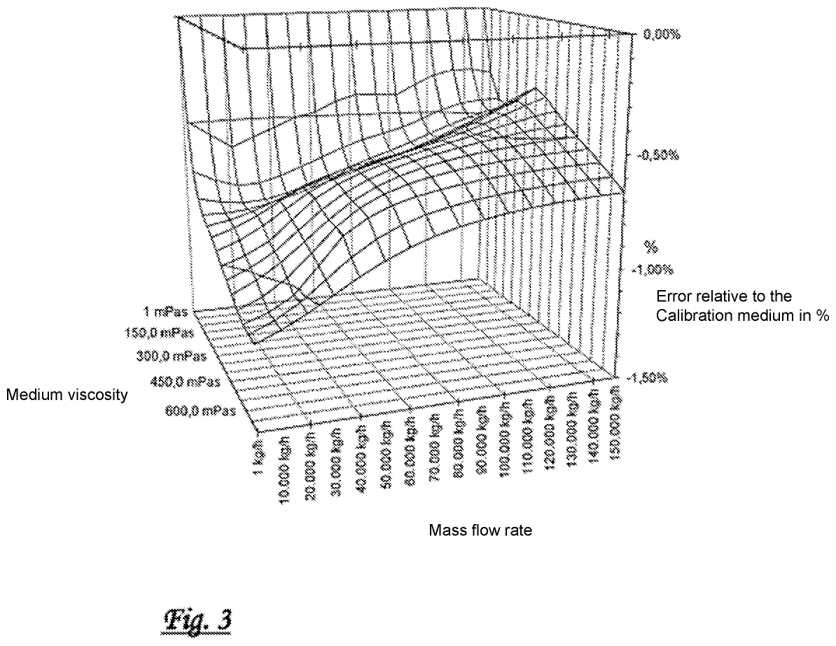

FIG. 3 shows a characteristic diagram developed from the table according to FIG. 2, as it can be used for a measurement that takes the medium viscosity into account.

The characteristic diagram according to FIG. 3 or the table according to FIG. 2 can be stored in advance in a memory of a measuring device electronics of the Coriolis flowmeter for further processing or for consideration in the evaluation. Alternatively, it is also possible to store the basic data set or a relatively coarse data field in the measuring device electronics and to use the kriging method or other interpolation methods, optionally also in combination, in the evaluation software during or after the measurement,

1. A method for determining a flow parameter of a medium, in particular a mass flow, by means of a Coriolis flowmeter of a certain type of measuring device, in which
the medium having a medium viscosity flows through at least one measuring tube piece that is excited to mechanical vibrations by means of an excitation signal,
at least one measurement signal that is dependent on the flow parameter, in particular a phase shift, is determined in the vibration behavior of the respective measuring tube piece, and
the flow parameter is determined from the at least one measurement signal, taking into account the dependence of the flow parameter on the medium viscosity, a data field determined by means of an interpolation method and showing the dependence of the flow parameter on the medium viscosity being used to determine the flow parameter.

2. The method according to claim 1, characterized in that the interpolation method for determining a data field is applied to a basic data set determined experimentally and/or by simulation.

3. The method according to claim 1, characterized in that the interpolation method is used when calibrating the device type.

4. The method according to claim 12, characterized in that the interpolation method is used for an evaluation during or after the determination of the at least one measurement signal.

5. The method according to claim 1, characterized in that at least kriging is also used as the interpolation method.

6. A device for determining a flow parameter of a medium, in particular a mass flow, by means of a Coriolis flowmeter, comprising
a) a transducer, the transducer having a measuring tube intended for the flow of a fluid, a vibration exciter for generating measurement signals in the form of mechanical vibrations on the measuring tube and vibration sensors for detecting the vibrations of the measuring tube, and
b) a measuring device electronics unit, the measuring device electronics unit being set up to determine a measured value for the desired flow parameter from measurement signals transmitted from the transducer to the measuring device electronics unit,
characterized in that
c) the measuring device electronics unit is set up to carry out the method according to claim 1.

7. The device according to claim 6, characterized in that the measuring device electronics unit has a data memory having a data field which shows the dependence of the flow parameter on the medium viscosity, wherein the data field is generated using an interpolation method.

8. The device according to claim 6, characterized in that the interpolation method is a kriging method.
